(19) United States
(12) Patent Application Publication
(10) Pub. No.: US 2022/0318873 A1
(43) Pub. Date: Oct. 6, 2022

(54) SYSTEM AND METHOD OF LEATHER PRODUCTS CUSTOMIZATION SERVICE

(71) Applicant: ARTHUR & GRACE INC., Seoul (KR)

(72) Inventor: Chae Yoon HAN, Seoul (KR)

(21) Appl. No.: 17/055,226

(22) PCT Filed: Sep. 9, 2020
(86) PCT No.: PCT/KR2020/012197

§ 371 Date: Nov. 13, 2020

(30) Foreign Application Priority Data
Aug. 31, 2020 (KR) 10-2020-0110427

(51) Int. Cl. G06Q 30/06

(52) U.S. Cl. CPC G06Q 30/0621; G06Q 30/0643

(57) ABSTRACT

A method of operating a server for products customization service according to an embodiment of the present invention includes providing product options providable to a purchaser, providing image information of a product selected by the purchaser among the product options, providing design options addable to the product, reflecting a design option selected by the purchaser among the design options to the image information of the product, and providing the image information of the product to which the design option selected by the purchaser is reflected.

### FIELD OF THE INVENTION

The invention relates to a production and sales system according to the design of leather products and a method for operating thereof, and is particularly concerned with a system and method of products customization service that customers are able to set out details such as size, inside and outside design and color of products, etc., thereby being able to order customized products.

### DESCRIPTION OF THE RELATED ART

There are apparent differences between propensity to consume of purchasers in the past and the present time. Nowadays consumers prefer to and are used to buying goods through the network with devices such as desktop PCs, tablets, smart phones, etc., while purchasers in the past checked with their eyes and bought goods directly offline.

Also, today's purchasers want to show themselves through individual goods in which their tastes and purpose are reflected. That is because the goods of which details such as color, design, etc. set by purchasers can express purchasers' individuality. However, there is a limitation that such requirements of purchasers cannot be met by existing ready-made goods. Existing ready-made goods not considered consumers' tastes, sizes, and characters bring about consumers' discontent from time to time. Thus, the invention provides with Leather Products Customization Service that purchasers are able to change and add designs according to purchasers' tastes and purpose, being provided basic design framework.

As such, it is necessary to provide Leather Products Customization Service for customers who want to customize products based on their tastes and preference but have no time to visit the offline stores.

### DETAILED DESCRIPTION OF THE INVENTION

### Technical Problem

The present disclosure provides a method of production and sales of leather products customization that is to design the items of the constituent elements of the leather products in various forms and have them as a form of library, and the purchasers directly online select constituent elements of designs from the library and combines them so that the leather products of designs desired by purchasers are able to be produced and sold.

In addition, the present disclosure provides a method of production and sales of leather products customization that displays virtually the design shape of the completed product combining the selected design options, when a customer selects a displayed product, desired design, color, size and so on from a database corresponding to a library. The library displays a various of products and includes design options.

In addition, the present disclosure provides a sales method in which a design sketch corresponding to a design shape is provided to a purchaser later on, and then production of a product is proceeded according to the purchaser's approval and payment.

### Technical Solution

A method of operating a server for products customization service according to an exemplary embodiment of the present disclosure may include the following steps: providing product information providable to a purchaser; providing basic image information of a product instructed by the purchaser's input information; providing design options information addable to the product; reflecting the design options information selected by the purchaser from among the design options information to image information of the product; and providing image information of the product in which design options information selected by the purchaser is reflected.

The design options information is information on at least one of a function addable to the product, a color of the product and a pattern of the product, and is determined according to the type of the selected product.

The providing of design options information that is addable to the product may further include: receiving separate design options information to be added to the product from the purchaser; and additionally providing the separate design options information.

The providing of the design options information that is addable to the product may include: generating a model for recommending a design option based on purchase details of the product by other purchasers; determining recommended design options by using a model for recommending the design option and input information of the purchaser; and providing information instructing that the recommended design options determined are to be a recommendation object.

The providing of the design options information that is addable to the product may include: generating at least one of recommended values among arrangement, configuration, and shape of the recommended design option by using a model for recommending the design option; and providing information of at least one of recommended values among arrangement, configuration, and shape of the recommended design option.

The providing of the design options information that is addable to the product may further include: storing the product characteristic information that the design options information selected by the purchaser is reflected in a database; and updating the model for recommending the design option by reflecting the design options information selected by the purchaser.

The providing of the design options information that is addable to the product may further include correcting at least one of the output position, direction, and shape of the design option selected by the purchaser.

The method may further include generating product order information based on product information that the design options information selected by the purchaser is reflected; generating predicted design information based on a product reflected the product order information; and providing the predicted design information.

The method may further include: receiving a message requesting for production status information of a product based on the predicted design information; and transmitting a response message to the message requesting for production status information of the product to the purchaser.

### Advantageous Effects of the Present Invention

According to an exemplary embodiment of the present disclosure, a purchaser is able to order desired leather products with various designs and functions online, thereby having an advantage of easily sell for seller leather products with various shapes to be fulfilled the taste of the purchaser.

In addition, according to an exemplary embodiment of the present invention, a customer is able to check in real time information such as an predicted production design and production status of a product from a designer based on an image of a product in the basis of the directly set detailed information, and gives the customer's feedback to the designer.

### BRIEF DESCRIPTION OF THE DRAWING

FIG. 1 is a block diagram showing an embodiment of the structure of a system for products customization service according to an exemplary embodiment of the present invention.

FIG. 2 is a flowchart illustrating an embodiment of the operation of the system for products customization service according to an exemplary embodiment of the present invention.

FIG. 3 is a flowchart showing an embodiment of the operation of the system for products customization service according to an exemplary embodiment of the present invention.

FIG. 4 is a schematic view illustrating an embodiment of an output result for selecting design options of products customization service according to an exemplary embodiment of the present invention.

FIG. 5 is a flowchart illustrating an operation of selecting a providable design option of products customization service according to an exemplary embodiment of the present invention.

### DETAILED DESCRIPTION OF THE EMBODIMENT

The present disclosure may be embodied in many different verification and embodiments, and specific embodiments will be illustrated in the accompanying drawings and described in detail. However, it is to be understood that the present disclosure should not be construed as being limited to the embodiments set forth herein, but is intended to cover various modifications, equivalents, and substitutes included within the spirit and scope of the appended claims.

Terms such as “first” and “second” may be used to describe various constituents, but the constituents should not be limited by the terms. These terms are used only for the purpose of distinguishing one constituent from another constituents. For example, without departing from the scope of the present invention, a first constituents may be referred to as a second constituents, and similarly, a second constituents may be referred to as a first constituents. The term “and/or” includes a combination of a plurality of related listed items or any of a plurality of related listed items.

When a component is referred to as being “connected” or “joined” to another component, it is understood that it may be directly connected or joined to the other component, but other components may exist in the middle. On the other hand, when a component is referred to as being “directly connected” or “directly joined” to another component, it is to be understood that there is no other component in the middle.

The terms used in the present disclosure are only used to describe specific embodiments and are not intended to limit the present invention. Singular expressions include plural expressions unless the context clearly indicates otherwise. In the present disclosure, terms such as “comprise” or “have” are intended to designate the presence of features, numbers, steps, actions, components, parts, or combinations thereof described in the specification, but it is to be understood that one or more other features, the presence or addition of elements or numbers, steps, actions, components, parts, or combinations thereof are not excluded in advance.

Unless otherwise defined, all terms used herein, including technical or scientific terms, have the same meaning as commonly understood by those skilled in the art. Terms as defined in a commonly used dictionary should be interpreted as having a meaning consistent with the meaning in the context of the related technology, and should not be interpreted as an ideal or excessively formal meaning unless explicitly defined in the present disclosure.

Hereinafter, the present invention will be described more fully with reference to the accompanying drawings. The drawings and description are to be regarded as illustrative in nature and not restrictive, and like reference numerals designate like elements throughout the specification, and duplicate descriptions for the same elements are omitted.

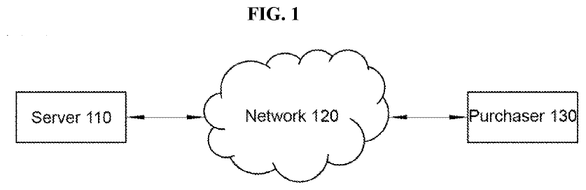

FIG. 1 is a block diagram showing an embodiment of the structure of a system for products customization service according to an exemplary embodiment of the present invention.

Referring to FIG. 1, the products customization service includes a server 110 and a purchaser's terminal 130 connected to the server 110 through a network 120. The products customization service is a system that provides a leather products customization order service in which a purchaser customizes and buy a desired design of leather product through a wired or wireless communication network. A purchaser accesses to the server to select the size and basic design of the leather product that he/she wants to purchase, and select other details such as the exterior and interior design, color, and whether or not to provide his/her initial. The method of leather products customization service includes displaying a web shopping mall in response to a connection to a purchaser terminal, displaying a predetermined item library of leather products in response to a selection of an order and sales menu, and displaying the leather product shape of the combined and selected design options in response to selection of a displayed design option library, and a payment menu. The purchaser checks the virtual model of the leather product that he/she desires on the internet through item libraries corresponding to the graphic shape of a plurality of items stored on the server, and the design desired by the purchaser is transmitted to the designer. The designer creates a design according to the purchaser's request and transmits it to the purchaser, and the purchaser accepts and pays for the leather product to start manufacturing. The production details of leather products are transmitted to the purchaser in real time.

The server 110 stores information for operating products customization service. The information for operating the products customization service includes leather products and design options information of each of the leather products that is provided by the operator of the products customization service. In addition, the server 110 stores purchase details information of existing purchasers of leather products.

The network 120 refers to a connection structure for exchanging information between the server 110 and the purchaser's terminal 130. The network 3320 includes internet, local area network (LAN), wireless local area network (wireless LAN), wide area network (WAN), personal area network (PAN), 3G, 4G, long term evolution (LTE), voice over LTE (VoLTE), 5G new radio (NR), wireless-fidelity (Wi-Fi), Bluetooth, NFC, radio frequency identification (RFID) home network, internet of things (IoT), and so on.

The purchaser's terminal 130 is connected to the server 110 through the network 120. In addition, the purchaser's terminal 130 includes a user device such as a computer, a tablet, and a smartphone. The purchaser's terminal 130 receives information for products customization service from the server 110, and downloads and installs a related app. The information for the products customization service includes products available for purchase through the products customization service and design options information that is addable to the products.

The purchaser's terminal 130 displays the received information for products customization service through an output device. In addition, the purchaser's terminal 130 receives design options information selected by the purchaser and displays an image of a product customized by the purchaser.

Products provided by the products customization service are leather products, but it will be apparent that products subject to service provision are not limited thereto. The operation of the server of the system for products customization service is as described below.

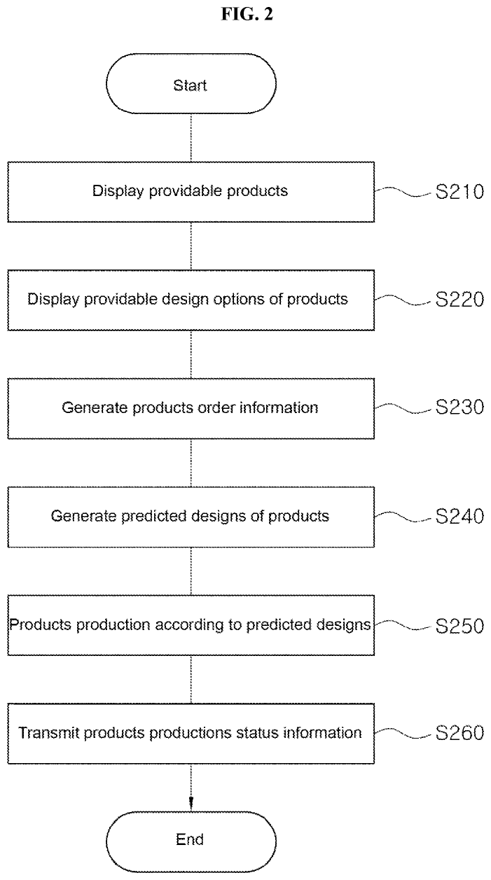

FIG. 2 is a flowchart illustrating an embodiment of the operation of the system for products customization service according to an exemplary embodiment of the present invention.

In step S210, a server of a system for products customization service (hereinafter, “server”) provides information on leather products that is providable to a purchaser. The server receives a message including input information of the purchaser from the purchaser. The input information of the purchaser includes information on a basic product selected by the purchaser among products. The server provides a basic image of the leather product indicated by the input information of the purchaser.

In step S220, the server provides design options information that is addable to the leather product. The server receives a message including input information of the purchaser from the purchaser. The input information of the purchaser includes design options information applicable to a leather product selected by the purchaser among leather products. The server reflects design options information to the image of the leather product. The design options information is selected by a purchaser among design options information that is addable to the basic image of the leather product.

In step S230, the server generates product order information based on product information reflected design options information selected by the purchaser. The server generates product order information based on information on the leather product selected by the purchaser and design options information to be addable to the leather product. The server transmits the generated product order information to a product manufacturer who provide product customization services.

At this time, in step S240, the manager of the product customization service generates predicted design information based on the product reflected the product order information. For example, the manager requests a product manufacturer who provides product customization service to produce a predicted design of a product based on the product order information. In addition, the manager receives information on the predicted design of the product from the product manufacturer.

In step S250, the manager of the product customization service produces a leather product based on the product order information and the predicted design. For example, the manager requests a product manufacturer who provides product customization service to produce leather products based on product order information and predicted designs.

In step S260, the server transmits production status information of a product to the purchaser. The manufacturer may periodically or non-periodically transmit production status information of a product to the server in the process of manufacturing leather products. The server receives a message requesting for providing production status information of a product from a purchaser. The server provides production status information of a product to the purchaser according to the request message.

The operation of the server, the purchaser, and the manufacturer for providing product customization service may be as described below.

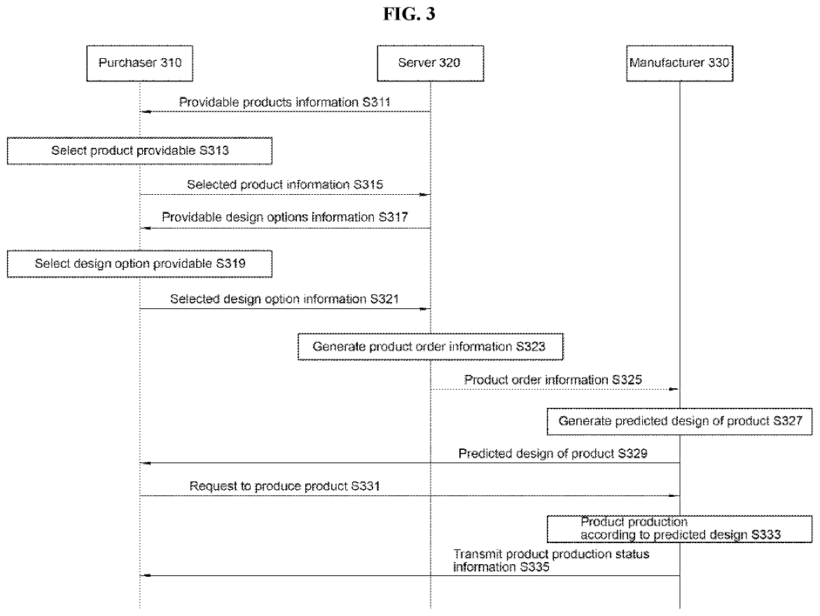

FIG. 3 is a showing an embodiment of the operation of the system for products customization service according to an exemplary embodiment of the present invention.

Referring to FIG. 3, a method of operating for products customization service is executed in a product customization system including a purchaser's terminal (hereinafter, “a purchaser”) 310, a server 320, and a manufacturer 330. For reference, the manufacturer 330 is referred to as a manufacturer for convenience of description but may correspond to a type of manufacturing system.

The server 320 provides images of products that are providable to the purchaser 310 (S311). The server 320 includes a database including product information that is providable to the purchaser 310. For example, when an object of product customization service is a leather product, the leather products providable includes a bag, a tote-bag, a clutch, a wallet and so on. The purchaser 310 receives a message including input information of the purchaser 310 from the purchaser 310, from the server 320 (S311).

The purchaser's device displays images of providable products that are obtained from the server 320. The purchaser's device displays images of leather products providable such as bags, tote bags, clutches, and wallets. The purchaser 310 selects one product from among the products providable that is displayed (S313). For example, the purchaser 310 determines one product, a tote bag, from among the products providable such as a bag, a clutch, and a wallet. The purchaser 310 transmits input information of the purchaser 310 to the server 320 (S315). The input information of the purchaser 310 includes information on the basic product selected by the purchaser 310 among the products.

The server 320 provides the purchaser 310 with images of design options information providable for the selected product (S317). The database of the server 320 may further include design options information that is providable. For example, when an object of product customization service is a leather product, design options include a design, a pattern, a color, and a functional configuration of the leather product. Functional configurations of the leather product include a separate storage space, a clip, and the like.

The providable design options information of the product which is transmitted by the server 320 can be determined according to the type of the selected product. For example, the server 320 provides only design options information providable of a leather product (e.g., a tote bag) selected by the purchaser 310.

The purchaser 310 receives a message including design options information providable from the server 320 (S317). The purchaser's device may display an image of design options information obtained from the server 320. The purchaser 310 selects one among design options providable that is displayed (S319). The output result from the purchaser's terminal for displaying the design options to the purchaser 310 may be as described below.

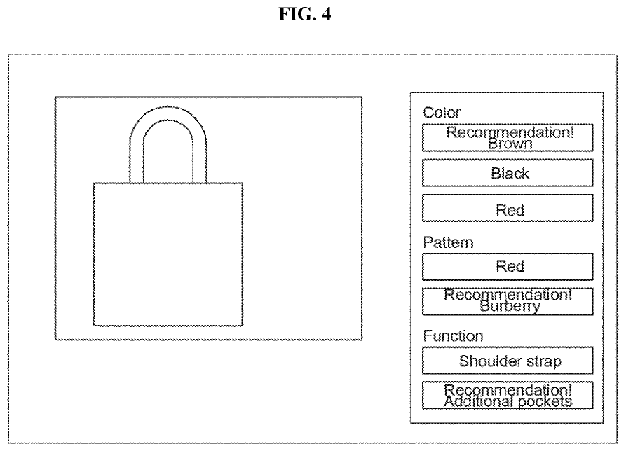

FIG. 4 is a schematic view illustrating an embodiment of an output result for selecting design options of products customization service according to an exemplary embodiment of the present invention.

Referring to FIG. 4, an output result for selecting design options of a product customization service is provided by a product customization system including a purchaser's terminal (hereinafter, “a purchaser”), a server and a manufacturer.

The output result for selecting the design options of the product customization service is displayed on the output device of the purchaser's terminal. The purchaser's terminal is a personal device such as a computer, a tablet, a laptop computer, or smartphone. The output device of the terminal is a display device such as a monitor. In addition, the output result for selecting design options is output in the form of a website or a page of an app on the purchaser's terminals.

A first part, which is a part of the screen output to the terminal, is a part for displaying a product. The first part displays the entire image of the leather product. Further, the first part displays images of the front, side, and rear of the leather product according to a purchaser's input. In addition, the first part displays 360 degrees images of the leather product according to the purchaser's input. In addition, the first part displays an image of a leather product reflecting design options information selected by a purchaser. For example, when information on at least one of colors, patterns, designs, and functional configurations selected by a purchaser is received, the server transmits image information of a product reflected design options selected by the purchaser to the purchaser's terminal. The purchaser's terminal which receives the image information of the product reflected design options selected by the purchaser displays the image of the product on the first part.

A second part, which is a part of the screen output to the terminal, is a part for displaying design options that are addable to the product. The purchaser selects at least one among design options displayed on the second part through an input device provided in the purchaser's device. As a result of selecting design options, the purchaser's device transmits the selected design options information to the server. In addition, recommendation signs are further displayed on some windows on the second part that displays design options. The purchaser's device further receives design options information of the recommendation object from the server and displays the recommended object on the website or a page of an app based on design options information received.

In addition, a part of the screen displayed on the terminal is a part for modifying design options information applied to the product. For example, a part of the screen output to the terminal provides an input tool for modifying colors, patterns, designs, and arrangement, organization, shape, etc. of functional configurations selected by a purchaser.

An operation of selecting a design options capable of providing a product customization service according to the output result illustrated in FIG. 4 may be as described below.

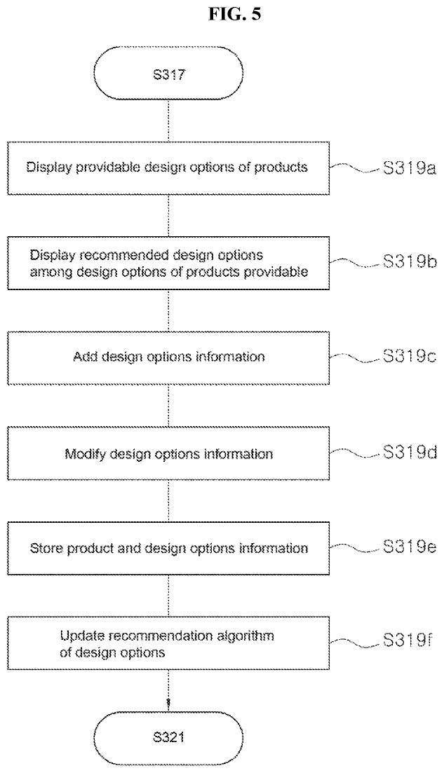

FIG. 5 is a flowchart illustrating an operation of selecting a providable design option of products customization service according to an exemplary embodiment of the present invention.

Referring to FIG. 5, an operation for selecting a providable design option of a product customization service is executed in a product customization system including a purchaser terminal 310 (hereinafter, “a purchaser”), a server 320, and a manufacturer 330.

In step S319A, the server provides design options for products providable in the product customization service. The server transmits the design options information of leather products providable in the product customization service to the purchaser. The purchaser receives the design options information of the leather product providable from the server.

In step S319B, the server provides recommended design options information among design options for products providable in the product customization service. The database of the server includes information on purchase details of leather products of existing purchasers. In addition, the server determines recommended design options among product design options providable in the product customization service based on the existing information on purchase details of leather products.

Specifically, the server generates recommended models of product design options, which are the recommendation of design options to be added to the product by using the accumulated information on purchase details of products of existing purchasers. The server recommends product design options according to a purchaser's input by using recommended models of product design options. In addition, the server derives recommended values such as arrangement information and shape of the recommended product design options according to a purchaser's input by using recommended models of product design options. The server provides recommendation information derived by using recommended models of product design options to the purchaser.

The recommended models of product design options may be a machine learning model comprised of an artificial neural network learned by using information on purchase details of products of existing purchasers. The artificial neural network is one of neural networks such as an artificial neural network (ANN), a convolutional neural network (CNN), and a multi-layer perceptron (MLP). The artificial neural network of the recommended models of product design options applies learning methods such as deep learning and enforcement learning.

The server provides information on recommended design options among design options for a product providable in a product customization service according to purchaser's input information. For example, the server obtains the type information of leather product to be purchased from a purchaser and provides design options information applicable to the leather product to be purchased and recommendable design options information among design options. The design options information of recommendation object first provided by the server may be referred to as a first recommendation object design option. The purchaser selects a first design option to be added to the leather product among design options, and transmits a message including information on the selected first design option to the server.

The server obtains the first design options information from the purchaser. In addition, the server recommends the arrangement, shape, and configuration of the first design option according to the purchaser's input information. For example, when the first design option is a pattern or functional configuration, the server uses the recommendation model of product design option learned in advance based on the product type information and the first design options information, and derives recommended values such as patterns, arrangement information of functional configuration, shapes, etc. For example, the recommended value may include information such as arrangement coordinates and specifications of the first design option. The server transmits the recommended value information for the first design option to the purchaser. The purchaser's terminal displays recommended value information for the first design option, and the purchaser determines the arrangement, shape, and configuration of the first design option based on the recommended value information for the first design option displayed.

The server obtains the first design options information from the purchaser. In addition, the server updates information on recommended design options among design options for leather products providable in the product customization service according to the purchaser's input information. The server provides design options information of recommendation object updated among design options based on the first design options information selected by the purchaser as well as the type information of the leather product. The design options information of recommendation object updated and provided by the server may be referred to as a second recommendation object design option.

The server, which is received the additionally selected second design options information from the purchaser, uses the recommendation model of product design option learned in advance based on the leather product type information and the first design options information or the second design options information to update recommended values such as patterns, arrangement information of functional configuration, shapes, etc. The server transmits information on the recommended value for the design option updated to the purchaser.

In other words, the server determines the design options to be recommended for the product based on the purchaser's input information, using the recommendation model of product design option generated based on the existing product purchase details information. The server provides recommendation result information of the determined design option to the purchaser. The purchaser's device receives the recommendation result information of the determined design option from the server. The purchaser's device displays the recommendation result information of the design option received from the server. The purchaser determines design options to be added to the product in consideration of the recommendation result of the design option displayed.

In step S319C, when desired design options do not exist among the design options output, the purchaser adds design options. The purchaser inputs desired design options information by an input device (e.g., a mouse, a touch pad, a tablet, etc.) provided in the purchaser's terminal. The desired design options information includes information of picture format or combination information of color codes in case of color. The purchaser transmits the desired design options information input to the server.

In step S319D, the purchaser modifies the desired design option among the design options output. The purchaser inputs option information to be modified through an input device (e.g., a mouse, a touch pad, a tablet, etc.) provided in the purchaser's terminal. The design options information to be modified includes combination information of a color code in case of color or information of picture format. The purchaser transmits the input design options information to be modified to the server.

In step S319E, the purchaser determines product and design options information. That is, the purchaser determines result values obtained by adding or modifying some selected design options and arrangement of design options among the design options information of leather products provided from the server. The purchaser transmits the determined leather product and design options information to the server.

The server receives product and design options information determined by the purchaser. The server stores product and design options information in the database and then updates purchase details of existing purchasers. The updated purchase details includes type information of leather product, design options information, and the design options information of shapes, arrangements, and configuration, respectively. And the server updates the recommendation algorithm of design options. For example, the server updates the recommendation algorithm of design options through reinforcement learning using the updated purchase details information. Specifically, the server updates the weight vector of the design options recommendation model through learning process.

Referring back to FIG. 3, the purchaser 310 transmits input information of the purchaser 310 including design options information selected by the purchaser 310 among products to the server 320 (S321). The server 320 receives input information of the purchaser 310 from the purchaser 310 (S321). The server 320 reflects design options information selected by the purchaser 310 among design options information addable to the basic image of the leather product to the image of the leather product.

The server 320 generates product order information based on product information reflected the design options information selected by the purchaser 310 (S323). The server 320 generates product order information based on leather products information selected by the purchaser 310 and design options information to be added to the leather product. The server 320 transmits the product order information generated to the product manufacturer 330 providing product customization services (S325). The manufacturer 330 receives product order information from the server 320.

The manufacturer 330 generates predicted design information based on the product reflected the product order information (S327). The predicted design information of the product is an image of a leather product in which design options information selected by the purchaser 310 is reflected. In addition, the manufacturer 330 transmits the generated predicted design information to the server 320. The server 320 receives the predicted design information of the leather product from the manufacturer 330 and transmits the received predicted design information of the leather product to the purchaser 310 (S329). The purchaser 310 receives predicted design information of the leather product from the server 320.

The purchaser 310 determines whether to purchase the product by checking the predicted design information of the product. In addition, the purchaser 310 checks the predicted design information of the leather product and request modification of the leather product. The server 320 transmits product modification request information to the manufacturer 330. The manufacturer 330 generates design information reflected product modification request information and transmits the design information generated to the server 320. The server 320 receives the modified design information of the product from the manufacturer 330 and transmits the modified design information of the product received to the purchaser 310. The purchaser 310 receives the modified design information of the product from the server 320.

The purchaser 310, who determined whether to purchase the product, transmits a message requesting for production of the product according to the predicted design to the server 320 (S331). The server 320 receives the message requesting for production of the product according to the predicted design from the purchaser 310. In addition, the server 320 transmits the message requesting for production of the product according to the predicted design to the product manufacturer 330.

Meanwhile, according to an exemplary embodiment of the present disclosure, the product order information S323 generated by the purchaser 310 includes not only the selected design options but also the amount for each of the selected design options and the first amount summed for the product. In other words, the generated product order information includes the first amount of the product, and when the purchaser 310 agrees with the first amount, the server 320 transmits product order information to the manufacturer 330.

The manufacturer 330 generates a predicted design of a product as described above based on the product order information, and at this time, the second amount in actually manufacturing the product is calculated and is transmitted along with the predicted design of the product to the purchaser 310 (S329).

In case the second amount is less than or equal to the first amount, the second amount is determined along with requesting production of the product of the purchaser 310 (S331) and the manufacturer 330 proceeds with product production.

In addition, in case the second amount exceeds the first amount, the server 320 transmits an additional message to the purchaser 310 inquiring whether or not to agree to the second amount, and when the purchaser 310 agrees to the second amount, the message requesting production of the product is transmitted to the manufacturer 330 so that product production is proceed (S331).

In contrast, when the purchaser 310 does not agree to the second amount, the manufacturer 330 generates and transmits a new predicted design providable within the range of the first amount to the purchaser 310, inquiring whether or not to agree thereto. When the purchaser 310 agrees to the new predicted design, a message requesting production of the product is transmitted to the manufacturer 330 so that product production is proceed.

The manufacturer 330 produces a product based on the product order information and the predicted design (S333). For example, the manufacturer 330 transmits the production status information of the leather product to the server 320 (S335). The purchaser 310 transmits the production status information of the leather product to the server 320. In addition, the server 320 provides the purchaser 310 with production status information requested from the purchaser 310. The purchaser 310 checks the production status of the product based on the production status information provided from the server 320. The manufacturer 330 completes production of the product and delivers the complete product to the purchaser 310.

Meanwhile, although not shown in the drawing, the size of the product is included in product-related design options which are selectable in the purchaser's terminal 130. Specifically, the server 110 provides a basic size (for example, a first size, a second size, etc.) for a product to the purchaser's terminal 130, and the purchaser selects any one specific size in the terminal 130.

In this case, the server 110 transmits a checking message indicating whether a specific size is appropriate to the purchaser's terminal 130. When the purchaser agrees to the checking process, the checking process proceeds. The checking process may proceed as follows.

The purchaser takes a picture of at least one item (for example, a bottle of lotion, a lipstick, a book, etc.) to be put into a product (for example, a bag) through the camera of the terminal 130. The purchaser's terminal 130 acquires volume of the at least one item respectively through the app installed in the terminal or the server 110. In case the sum of the volume of the at least one item is smaller than the volume of the specific size, a message indicating that the specific size is appropriate is displayed on the terminal 130. Conversely, in case the total volume of the at least one item is larger than the volume of a specific size, a message indicating that the specific size is inappropriate is displayed on the terminal 130, and the smallest size among a plurality of sizes larger than the total volume is recommended.

In another exemplary embodiment of the present disclosure, the server 110 does not provide a basic size to the purchaser's terminal 130, but first at least one item (for example, a bottle of lotion, a lipstick, a book, etc.) that the purchaser wants to put into a product (for example, a bag) is taken pictures of one by one through the terminal 130. Then, a specific size larger than the sum of the at least one item photographed is recommended and displayed on the terminal 130. Here, the specific size corresponds to the smallest size among a plurality of sizes larger than the sum of the at least one item.

Eventually, a size that contains all the items into which the purchaser wants to put (for example, a bottle of lotion, a lipstick, a book, etc.) is selected. Information thereon is also included in the design options and is used to generate product order information in the server 110.

The methods according to the present disclosure are implemented in the form of program instructions that can be executed through a various of devices like computers and recorded in a computer-readable medium. The computer-readable medium may include program instructions, data files, data structures, and the like alone or in combination. The program instructions recorded on the computer-readable medium may be specially designed and configured for the present invention or may be known and usable to those skilled in computer software.

Examples of computer-readable media may include hardware devices specially configured to store and execute program instructions such as rom, ram, flash memory, and the like. Examples of program instructions may include not only machine language codes such as those produced by a compiler, but also high-level language codes that can be executed by a computer using an interpreter or the like. The above-described hardware device may be configured to operate as at least one software module to perform the operation of the present invention, and vice versa.

Although described with reference to the above exemplary embodiments, those skilled in the art will understand that various modifications and changes can be made to the present invention without departing from the spirit and scope of the present invention described in the following claims.

1: A method of operating a server for products customization service, the method comprising:
providing product options providable to a purchaser;
providing image information of a product selected by the purchaser among the product options;
providing design options addable to the product;
reflecting a design option selected by the purchaser among the design options to the image information of the product; and
providing the image information of the product to which the design option selected by the purchaser is reflected.

2: The method of claim 1, wherein the design options comprise at least one of a function addable to the product, a color of the product and a pattern of the product, and are determined according to the type of the selected product.

3: The method of claim 1, wherein the providing of design options, further comprises:
receiving a separate design option to be added to the product from the purchaser; and
additionally providing the separate design option.

4: The method of claim 1, wherein the providing of the design options comprises:
generating a machine learning model for recommending a design option based on a history of design options added to the product by other purchasers;
determining a recommended design option by using the machine learning model for recommending the design option and the product selected by the purchaser; and
providing information informing the purchaser of the recommended design option.

5: The method of claim 4, wherein the determining of the recommended design option further comprises:
generating at least one of additional recommended options in addition to the recommended design option, the at least one of additional recommended options selected from the group consisting of an arrangement, a configuration, and a shape of the recommended design option by using the machine learning model for recommending the design option; and
providing information of the at least one of the additional recommended options to the purchaser.

6: The method of claim 4, wherein the providing of the design options further comprises:
storing the image information of the product to which the design option selected by the purchaser is reflected in a database; and
updating the machine learning model for recommending the design option by reflecting the design option selected by the purchaser.

7: The method of claim 1, further comprising:
editing at least one of an output position, a direction, and a shape of the image information of the product to which the design option selected by the purchaser is reflected.

8: The method of claim 1, further comprising:
generating order information based on the product with the design option selected by the purchaser;
generating predicted design information of the product based on the product with the design option; and
providing the predicted design information.

9: The method of claim 8, further comprising:
receiving a message requesting for production status information of the product which is being produced based on the predicted design information; and
transmitting a reply message in response to the message requesting for production status information of the product to the purchaser.

10: The method of claim 4, wherein the machine learning model comprises an artificial neural network.

11: A method of operating a server for products customization service, the method comprising:
providing product options providable to a purchaser;
providing image information of a product selected by the purchaser;
providing design options addable to the product, the design options comprising at least one of a function addable to the product, a color of the product and a pattern of the product, the providing of the design options comprising:
generating a machine learning model for recommending a design option based on a history of design options which were added to the product by other purchasers;
determining a recommended design option by using the machine learning model for recommending the design option and the product selected by the purchaser;
providing information informing the purchaser of the recommended design option;
storing the image information of the product to which the design option selected by the purchaser is reflected in a database; and
updating the machine learning model for recommending the design option by reflecting the design option selected by the purchaser,
wherein the determining of the recommended design option further comprises:
generating at least one of additional recommended options in addition to the recommended design option, the at least one of additional recommended options selected from the group consisting of an arrangement, a configuration, and a shape of the recommended design option by using the model for recommending the design option; and
providing information of the at least one of the additional recommended options to the purchaser.
